(19) United States
(12) Patent Application Publication
(10) Pub. No.: US 2019/0129492 A1
(43) Pub. Date: May 2, 2019

(54) COMPUTER SYSTEM, CLIENT DEVICE AND DISPLAY DEVICE

(71) Applicant: Fujitsu Client Computing Limited, Kawasaki-shi (JP)

(72) Inventors: Angel Chen, München (DE); Johann Schweinfort, München (DE); Andreas Maier, München (DE)

(21) Appl. No.: 16/171,573

(22) Filed: Oct. 26, 2018

(30) Foreign Application Priority Data
Oct. 27, 2017 (DE) 102017125284.3
Jan. 12, 2018 (EP) 18151438.1

(51) Int. Cl. G06F 1/32; G06F 11/30; G06F 1/26

(52) U.S. Cl. CPC G06F 1/3218; G06F 1/3234; G06F 1/266; G06F 11/3062; G06F 1/3231

(57) ABSTRACT

A computer system includes a client computing device; and a display device operationally connected to the client computing device by a Universal Serial Bus, USB, interface, wherein the display device includes at least one power control device including at least one of a power button and a user presence sensor; and upon activation, the at least one power control device changes an operating state of the client computing device by sending at least one predefined Human Interface Device, HID, command or a resume signal over data lines of the USB interface to the client computing device.

### TECHNICAL FIELD

This disclosure relates to a computer system comprising a client device and a display device operationally connected to the client device, as well as a so-called all-in-one mode of a display device in combination with a client computing device.

### BACKGROUND

Usually a client device, for example, a personal computer (PC), and a display device such as a flat screen display device are equipped with separate power buttons and LED status indicators that operate independently from each other. For example, the action of pressing the display's power button will only turn off the display device, but will not influence the PC's power state.

Especially with small form factor client devices such as mini PCs or thin clients, which are mounted under the table or behind the screen of a display device, for example, by using a VESA mounting kit, there is no direct access to the power button of the client device, and the status LED, also called power LED, of the client device is not in the user's field of view. Thus, when the PC and the display device are controlled separately, it may be difficult to change the PC's power state and/or to ascertain the PC's power state.

It may be possible to control the power state of the PC using some specific keyboards with an integrated power button. However, those keyboards do not have an LED indication to reflect the current PC power state. Thus, pressing the power button on the keyboard could lead to unintended, even opposite reactions of the PC. For example, a user is expecting the PC to be in a sleep state because the display device is showing a black screen. However, the PC might actually be in an active state and the screen of the display device may only be black because no active signal was found after a certain amount of time. If the user wants to wake up the PC by pressing the power button, instead he or she will actually send the PC to the sleep state in this situation. This will lead to confusion for the user, especially because there is no visible LED indicator to reflect the current PC power stage.

Accordingly, there is a need to provide alternative and/or improved computer systems that allow to control and, optionally, ascertain the current power state of a client device.

### SUMMARY

We provide a computer system including a client computing device, and a display device operationally connected to the client computing device by a Universal Serial Bus, USB, interface, wherein the display device includes at least one power control device including at least one of a power button and a user presence sensor, and upon activation, the at least one power control device changes an operating state of the client computing device by sending at least one predefined Human Interface Device, HID, command or a resume signal over data lines of the USB interface to the client computing device.

We also provide a client computing device including at least one processor that executes program code, a graphics component that generates graphical output to be displayed based on the program code executed by the at least one processor, a power management subsystem that switches the client computing device into different operating states, including at least one normal operating state in which the at least one processor is supplied with an operating energy, and at least one energy saving state in which the at least one processor is not supplied with the operating energy or supplied with a reduced amount of operating energy, and at least one Universal Serial Bus, USB, interface to connect the client computing device to an external display device, wherein the power management subsystem controls the operating state of the client computing device based on a first control signal received from the external display device over data lines of the USB interface, the first control signal including at least one predefined Human Interface Device, HID, command or a resume signal according to the Universal Serial Bus, USB, protocol and indicating a request for the power management subsystem to change the operating state of the client computing device, and one of the power management subsystem and the USB interface transmits a second control signal to the external display device indicating a change in a current operating state of the client computing device.

We further provide a display device including a display screen that displays graphical output, at least one power control device including at least one of a power button and a user presence sensor, at least one USB interface that connects the display device to an external client computing device, and control circuitry operationally connected to the at least one power control device and the at least one USB interface, wherein the control circuitry monitors the at least one power control device and, upon activation of the at least one power control device, transmits a first control signal including at least one predefined Human Interface Device, HID, command or a resume signal according to the Universal Serial Bus, USB, protocol over data lines of the USB interface to the client computing device indicating a request to change the operating state of the client computing device.

### BRIEF DESCRIPTION OF THE DRAWINGS

FIG. 1 shows a block diagram of an example of a computer system.

FIG. 2 shows a block diagram of internal components of a display device connected to a client device according to an example.

FIG. 3 shows a first flowchart of a first operating method according to an example.

FIG. 4 shows a second flowchart of a second operating method according to an example.

FIG. 5 shows a third flowchart of a third operating method according to an example.

### LIST OF REFERENCES

1 computer system
2 client device
3 display device
4 data connection
5 interface (of the client device)
6 interface (of the display device)
7 power button
8 status LED
9 display screen
10 control circuitry
11 processor
12 graphics component
13 power management subsystem
14 presence sensor
21 USB interface
22 first control path
23 second control path
24 USB hub
25 scaler
26 user interface
27 power delivery path
28 load detection circuit
29 power delivery controller

### DETAILED DESCRIPTION

Our computer system comprises a client device, in particular a client computing device such as a thin client PC or a mini PC, and a display device, in particular a flat screen display device, operationally connected to the client device by a Universal Serial Bus (USB) interface. The display device comprises at least one power control device, in particular a power button and/or user presence sensor, configured to, upon activation of the at least one power control device, change an operating state of the client device by sending at least one predefined Human Interface Device (HID) command or a resume signal over the USB interface to the client device.

The display device may further comprise at least one power indication device, in particular at least one status LED, configured to indicate a current operating state of the client device.

The idea is to use the display's power button and, optionally, LED status light to control and, optionally, indicate the client device's power state.

In this way, the display device's behavior and the client device's behavior of the power button and the LED are synchronized. This improves the user experience of the client device and display device combination and is beneficial especially if the client device cannot be directly accessed by the user, for example, because it is mounted behind the display device or under the table or the like.

This behavior may be implemented as follows:

The display device can send pre-defined human interface device (HID) commands to the client device, for example, by using the USB protocol to put the PC into a sleep state or other energy saving state once the power button of the display device is pressed in an active state of the client device.

Moreover, the display device may send a specified “resume” signal to the client device to wake up the client device, for example, a USB resume signal once the power button is pressed again in a sleep state or other energy saving state of the client device.

For easier reference, any operating state of the client device having a typical power consumption below that of a normal operating state, in particular the ACPI state S0, is considered to represent an energy saving state, in particular the standard ACPI states S1 to S5, as well as any vendor specific energy saving states.

For example, a display device could control the power state of a PC from ACPI state S0 (“active,” or “working” or “normal operating”) to ACPI state S3 (“standby,” “sleep” or “suspend to RAM”) and/or to ACPI state S5 (“off,” “soft-off,” or “switched-off”) by a display power button at the front side of the display device. In different PC and display states, the power button triggers different control signals, e.g., HID reporting commands or a resume signal, to the source side, i.e., the client device, by USB signaling.

Moreover, it is possible to combine a display device comprising a proximity sensor, also known as presence sensor, and a USB interface, preferably a USB Type-A or Type-C interface, that extends the security protection from the display device to PC devices. Using a list of pre-defined HID commands, corresponding commands can be recognized easily and widely by PCs and laptops, and would not be limited to devices of a specific manufacturer.

The display may detect the PC's power state automatically, for example, based on a power consumption level of the client device or control signals. With both alternatives, the display device is always able to recognize the client's device power state.

For example, a power delivery controller will detect the state of an external PC by a power drawing load for each different state. The load may be measured by establishing a current drawn at a supply interface, or may be established by analyzing requests for power according to a power delivery protocol. Based on this result, the power delivery controller can be the master side to notify a display scaler to reflect the current state of PC side on a LED indicator at the display front bezel. For example, a power delivery controller integrated into the display device may detect whether the current power consumption level lies below or above one or more predefined thresholds. For example, a power consumption of less than 1 Watt can indicate that the client device is switched off. A power consumption of between 1 and 5 Watt can indicate that the client device is in a sleep state. A power consumption in excess of 5 Watt can indicate an active operating state of the client device.

Alternatively, the client device can transmit control information to the display device to inform the display device of a selected operating mode and/or control the behavior of the status LED or power button of the display device directly. For example, the client device can send a proprietary HID commands via a standard USB interface, e.g., a USB Type-A interface, comprising information for a specified LED or power button. For example, when the PC changes from the ACPI state S0 to the ACPI state S3, the BIOS system of the client device will send a specified USB HID command to the display device. With this information, the display device is able to set the correct behavior for the status LED and power button behavior, for example, it may switch the status LED into a blinking mode. Besides, the display power button can also control the PC (“active” to “turn-off,” or “turn-off” to “turn on”) based on the current PC state to decide what kind of command is working to change the PC state.

The data required for power control and power state may be signaled using the USB human interface device (HID) class, rather than the USB monitor control class. The USB monitor control class only defines a protocol for user control such as brightness, contrast, size and position. Using the HID report system instead, user devices such as keyboards and/or mice can be emulated by the display device and used to interact with a power control subsystem of the client device to activate a specific operating state or mode of the client device, for example, working, sleep, hibernate, standby, soft-off and the like, or to signal specific state or mode changes like shutdown or wake-up.

As described in more detail later, the HID commands can be transmitted and received by a specific display internal controller, for example, a billboard device of a power delivery solution of the display device, an all-in-one integrated USB Type-C controller, or a HID control device integrated into a USB hub controller of the display device. A power delivery controller can also be used to translate the display device internal commands to HID standard commands to wake-up or force a PC into a sleep state or mode. Alternatively or in addition, the client device may also communicate with the display device using proprietary control signals such as vendor defined messages (VDM) as provided by the USB Power Delivery Standard Revision 3.0.

For USB HID usage tables and specification concerning the HID commands, reference is made to the respective USB specification available on-line, in particular for USB 1.0, 1.1, 2.0, 3.0, 3.1 and 3.2.

Our systems and devices will be described in more detail below with respect to the following figures. Therein, the same reference symbols are used for the same or similar components of different examples.

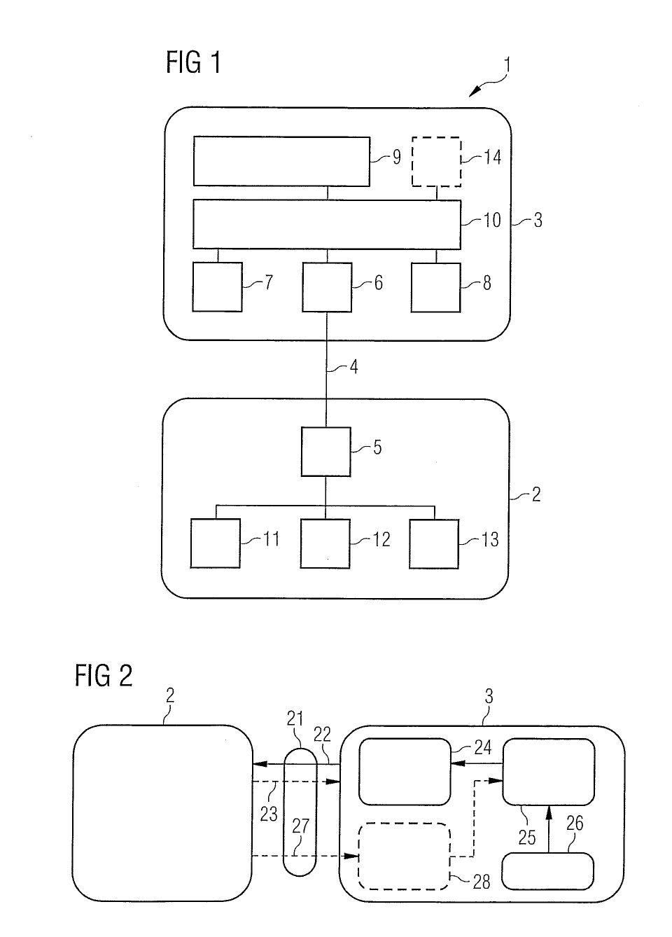

FIG. 1 shows an example of a computer system 1. The computer system 1 comprises a client device 2 such as a mini PC or a thin client device, and a display device 3 such as a flat screen LCD display device. The client device 2 and the display device 3 are connected by a data connection 4. For example, the client device 2 and the display device 3 may connect by a full featured USB Type-C cable comprising a plurality of wires that enable USB data paths, transferring video data using a display port connection and provide power from the display device 3 to the client device 2 by a power delivery standard. The data connection 4 is attached to the client device 2 by a first interface 5, in particular a first USB interface, and to the display device 3 by a second interface 6, in particular a second USB interface. In the example, the client device 2 is connected to the display device 3 using only a single cable, which is used to supply the client device 2 with an operating energy provided by the display device. Alternatively, several cables may be used, e.g., a combination of conventional display and USB Type-A cables. The client device 2 may be obscured partly or in total by the display device 3.

The display device 3 comprises a power button 7, a status LED 8, a display screen 9 and control circuitry 10. The client device 2 comprises a processor 11 that executes user programs as well as an operating system, driver and firmware components, a graphics component 12 that generates graphical output to be displayed by the display screen 9 and a power management subsystem 13 to control the operating state of the client device 2. The graphics component 12 and the power management subsystem 13 may be implemented in hardware or in software or a combination thereof. For example, the power management subsystem 13 may comprise parts of a system firmware for ACPI control such as a BIOS, parts of an operating system and hardware components used to activate or deactivate individual components or subcomponents of the client device 2.

In operation of the computer system 1, power control commands received by the display device 3 via the power button 7 are forwarded by the control circuitry 10 via the data connection 4 to the power management subsystem 13 of the client device 2. Inversely, the power state of the client device 2 is communicated via the data connection 4 to the control circuitry 10 of the display device 3 and indicated using the status LED 8.

The behavior of the power button 7 may be as follows. By pressing the power button 7 of the display device 3, it will send a HID command to put the connected client device 2 into a predefined energy saving state like the ACP state S3. The actual state may, however, depend on power settings defined, for example, in the operating system run by the client device 2. By pressing the power button 7 of the display device 3 again, it will wake up the connected client device 2 from its sleep state using a resume signal, in particular a USB resume signal.

Instead of sending a single HID command to the client device 2 to activate a single, predefined energy saving state, the control circuitry 10 of the display device 3 can also determine how long the power button 7 was pressed. If it was pressed for less than two seconds, then a first HID command for activation of a first energy saving state is sent, for example, to switch the client device 2 into a sleep state, i.e., ACPI S3. If the power button 7 is pressed for more than two seconds, then a second HID command for activation of a second energy saving state like is sent, for example, to shut down the client device 2 to a soft off state, i.e., ACPI S5, or activate a hibernate state, i.e., ACPI S4.

In another example, instead of a manual push button such as the power button 7, an optional presence sensor 14 integrated into the display device 3 may be used for automated power saving and/or locking of the client device 2. Instead of manually pressing the power button 7 to control the power state of the client device 2, the user presence sensor 14, also called human presence or proximity sensor, integrated into the display device 3 can be used to automatically send appropriate HID commands and/or USB resume signals to the client device 2. In this case, if the user leaves a detection area of the presence sensor 14, then a part of the control circuitry 10 of the display device 3 such as a scaler IC will send a HID command for “lock PC” or “sleep” to the client device 2 automatically after a predefined time period, for example, after 30 seconds of user absence. If the user re-enters the detection area of the presence sensor 14, then the display device 3 will send the USB resume signal to the client device 2 automatically to wake up the computer system 1 and show the log-on screen of the client device 2 without any further user intervention.

The behavior of the status LED 8 of the display device 3 may be as follows. If the client device 2 is in a sleep state, then the status LED 8 of the display device 3 will start blinking to indicate the sleep state of the client device 2 to the user. If the client device 2 is in an active working state, then the status LED 8 of the display device 3 will be illuminated continuously to indicate this state.

Preferably, the status LED 8 of the display device 3 should behave the same way as a status LED of the client device 2 if such a status LED is present in the client device 2.

An additional, optional feature may make use of different colors of the status LED 8. If a compatible client device 2 is detected, for example, a client device 2 of the same manufacturer as the display device 3 supporting the above mentioned exchange of power control commands and states, then the color of the status LED 8 will be changed from a first color specific for a standalone operating mode of the display device 3, for example, blue, green or amber to a second color specific to the status indicator of the client device 2, for example, white to indicate a so-called “all-in-one mode” to the user of the computer system 1 (instead of the display device's 3 standalone operating mode).

FIG. 2 shows a block diagram of internal components of a display device 3 connected to a client device 2 according to an example. Specifically, FIG. 2 shows a schematic diagram of the various data paths within the display device 3. The block diagram of FIG. 2 shows, in particular, those parts of a chip set of a display device 3 responsible for exchanging information with the client device 2 for power control and indication.

The client device 2, acting as a source for a display signal, and the display device 3, acting as a sink for the display signal, are connected by a USB interface 21, for example, a USB Type-A or Type-C data cable. The USB interface 21 comprises a first control path 22 to send control signals from the display device 3 to the client device 2, and an optional second control path 23 to send control signals from the client device 2 to the display device 3. On the side of the display device 3, both control path 22 and 23 end at a USB hub 24. The USB hub 24 comprises an internal component such as a microcontroller, for providing native HID support, i.e., to transmit and receive control commands according to the USB HID device class. Alternatively, a further component providing HID support can be connected internally to a conventional USB hub (not shown in FIG. 2). As described below, such functionality may also be provided by other components of the display device such as a power delivery controller or a so-called billboard device of a Type-C USB interfaces.

The display device 3 further comprises a scaler 25 to scale the display signal provided by the client device 2 and a user interface 26 to display the display signal to a user of the client device 2. The scaler 25 represents the main processing unit inside the display device 3. The user interface 26 is also used to display and control the operating state of the display device 3 and, according to the example, the client device 2. For example, the user interface 26 may comprise the power button 7, the status LED 8, the display screen 9, and the optional presence sensor 14 of the display device 3 according to FIG. 1. It may further comprises other components for user interaction such as an on-screen display (OSD) menu and corresponding OSD buttons, or a web-cam (not shown). The user interface 26 is connected with the scaler 25 by a suitable first control interface, for example, a first I²C bus and/or one or more dedicated control lines connected to corresponding general purpose I/O (GPIO) pins of the scaler 25. Similarly, the scaler 25 and the USB hub 24 are connected by a second control interface, for example, a second I²C bus.

In operation, a power control device of the user interface 26 may generate a control signal indicating activation of the power control device to the scaler 25. The scaler will monitor the control signal and generate a further control signal indicating a mode change of the display device to the USB hub 24. In turn, the USB hub 24 will receive the further control signal and translate it into a corresponding USB HID command or USB resume signal and send it via the first control path 22 to the client device 2 to request a corresponding mode change.

Optionally, the client device 2 can send further USB HID commands back to the display device using the second control path 23. Such USB HID commands may be proprietary or vendor specific and can be used to inform the scaler 25 of the current operating state of a compatible client device 2. The scaler 25 may then indicate the operating state through the user interface 26 to a user, for example, by the status LED 8.

Alternatively or in addition, the USB interface 21 may also comprise a power delivery path 27. Moreover, the display device 3 may comprise a load detection circuit 28 connected to the power delivery path 27 and the scaler 25. The connection between the scaler 25 and the load detection circuit 28 may also be implemented by an I²C bus, for example, the second I²C bus. The load detection circuit 28 may either act as a master or slave device on the I²C bus. In operation, the load detection circuit 28 can monitor the amount of power drawn by any client device 2 via the USB interface 22 and determine an actual operation state of the client device 2 based on a comparison of the power drawn by the client device 2 with one or more thresholds.

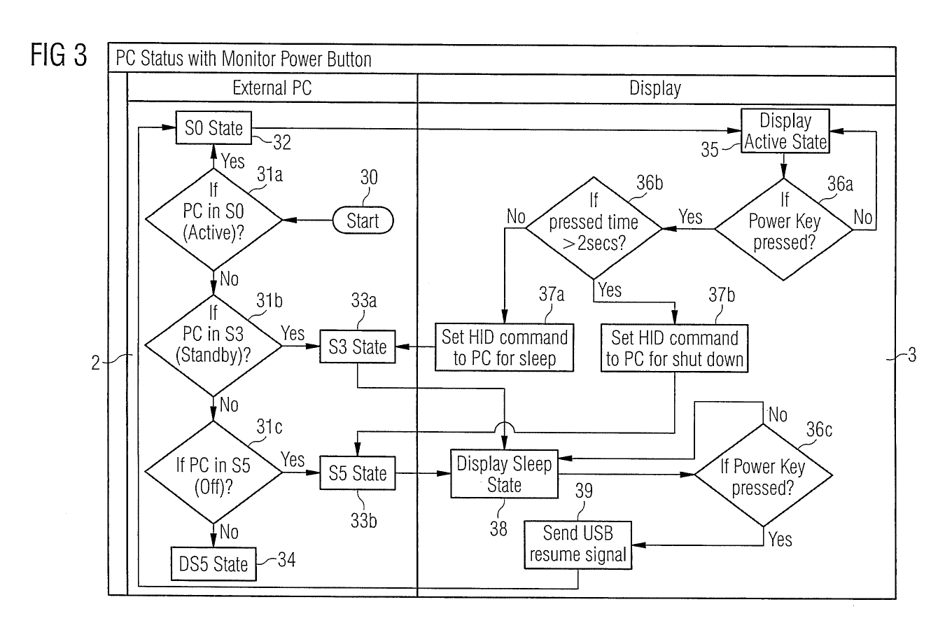

Operation of various inventive examples is described in more detail below with regard to the flowcharts provided in FIGS. 3 to 5.

FIG. 3 shows a flowchart of a method of operating the computer system 1. Therein, the states and actions of a client device 2 in the form of an external PC are shown on the left-hand side, whereas the states and actions of the display device 3 are shown on the right-hand side.

Upon initialization of the control method (box 30), the client device 2 first establishes (box 31a) whether it is in a fully operational state, i.e., ACPI state S0 (box 32), or another state. In the latter case, the client device 2 further establishes (box 31b) whether it is in a first energy saving state, e.g., ACPI state S3 (box 33a) or another energy saving state. In the latter case, the client device 2 further establishes (box 31c) whether it is in a second energy saving state, e.g., ACPI state S5 (box 33b), or a vendor specific deep sleep state DS5 (box 34), with a particular low power consumption not defined in the ACPI standard. In the deep sleep state DS5, all external interface of the client device 2 are deactivated. Accordingly, in this mode it is not possible to wake up the client device 2 using a USB interface 26 to the external display device 3.

If the client device 2 is in the ACPI state S0 (box 32), the display device 3 will enter a “display active” state (box 35). The display device 3 will remain in the “display active” state until the power button 7 is pressed (box 36a). Upon release of the power button 7, the display device 3 will determine how long the power button 7 was depressed (box 36b). If it was pressed down for less than two seconds, the display device 3 will send a first HID command to the client device 2 to switch the client device 2 into a sleep state (box 37a). In response, the client device 2 will enter the first energy saving mode, i.e., the ACPI state S3 (box 33a). If the power button 7 is pressed down for more than two seconds, the display device 3 will send a second HID command to the client device 2 to shut-down the client device 2 (box 37b). In response, the client device 2 will enter a second energy saving mode, i.e., the ACPI state S5 (box 33b).

The display device 3 may automatically detect that the client device 2 has entered the corresponding state successfully based on a power consumption of the client device 2 or based on control signaling between the client device 2 and the display device 3 such as the provision of a corresponding vendor defined message (VDM) from the client device 2 to the display device 3. Once the client device 2 has successfully entered one of the energy saving states, the display device will enter a corresponding “display sleep” state (box 38).

The computer system 1 will remain in this state until a user presses the power button 7 of the display device 3 again (box 36c). If such an event is detected, the display device 3 will send a USB resume signal to wake the client device 2 up (box 39). The USB resume signal is defined in the underlying USB standard, independent of the specific definition of the HID device class, and comprises switching the polarity of data lines D+ and D− of the USB interface 21 for a predetermined amount of time. The USB resume signal will be received and analyzed by the client device 2, for example, its power management subsystem 13, and triggers a state change into the ACPI state S0 (box 32). This state change will again be detected by the display device 3 based on the power consumption of the client device 2 or may be actively communicated from the client device 2 to the display device 3. In either way, the display device 3 will move into the “display active” state (box 35), where it remains until the power button 7 is pressed again.

A user of the client device 2 may also activate the ACPI state S3 (box 33a) or any other operating state of the client device 2 manually by selecting a corresponding control element of a user interface of the client device 2 or timer-based by configuring the power management subsystem 13 accordingly.

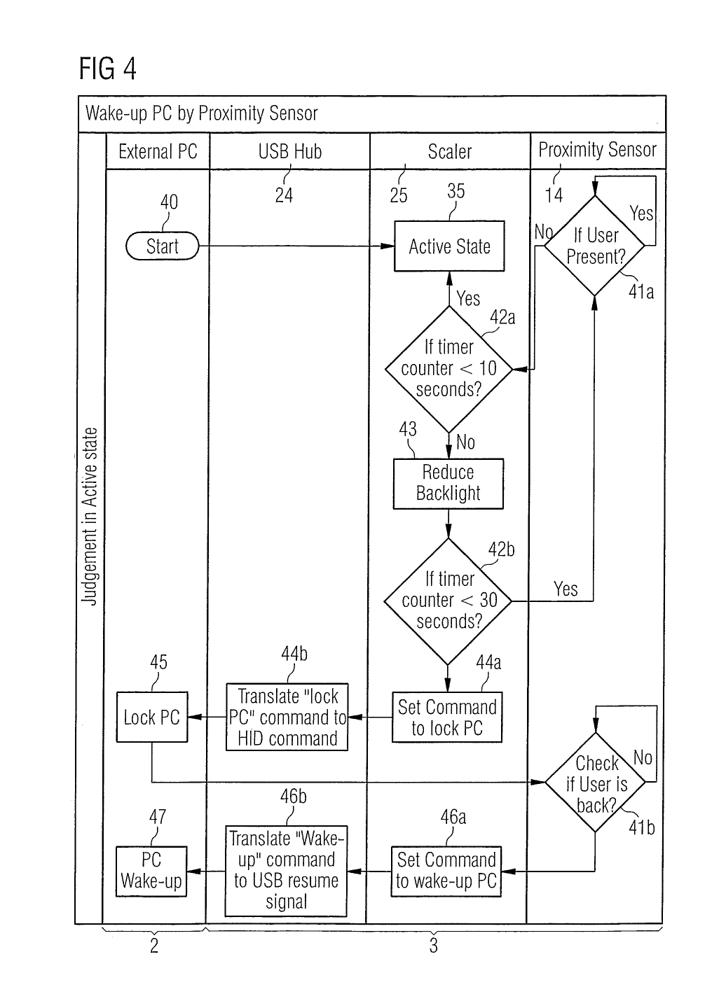

FIG. 4 shows a flowchart of an alternative operating method for a computer system 1.

The display device 3 comprises a presence sensor 14 that monitors a working area in front of a display screen 9, a USB hub 24 and a scaler 25. The power management of the client device 2 is automated based on the output of the presence sensor 14 as detailed below.

Assuming that the client device 2 is initially active (box 40), the display device 3 will also remain in an active state (box 35) as long as the presence of a user is detected by the proximity sensor 14 (box 41a). In the case that the user leaves the detection area, a timer will be initialized. For the first ten seconds of the timer running (box 42a), the computer system 1 remains in the active state (box 35). If the ten seconds have elapsed, the backlight of the display screen 9 will be reduced (box 43). Meanwhile the timer continues to run. If a return of the user is detected before 30 seconds of the time have elapsed (box 42b), the timer is reset and the display device 3 returns to the active state (box 35), i.e., increases the backlight to a predefined setting.

However, after 30 seconds of the timer without the detection of a user presence (box 42b), the scaler 25 of the display device 3 will send an internal “lock PC” command to the USB hub 24 (box 44a) of the display device 3. The USB hub 24 will translate the “lock PC” command to an HID command according to the USB HID profile (box 44b), which will then be communicated via the first USB control path 22 to the client device 2. In response, the power management subsystem 13 of the client device 2 will lock the client device 2 (box 45), for example, by activating a lock screen of the operating system or activating a predefined energy saving state.

The client device 2 will remain in this state until the presence sensor 14 (box 41b) detects that the user has returned into the working area. In this case, the scaler 25 will send a corresponding internal “wake-up” command to the USB hub 24 (box 46a). The USB hub 24 will translate the “wake-up” command into a USB resume signal (box 46b), which will be transmitted to the client device 2. In response, the client device 2 will be woken up (box 47), for example, by leaving the predefined energy saving state and/or displaying a log-in screen for the user, allowing the user to enter a password to unlock the PC.

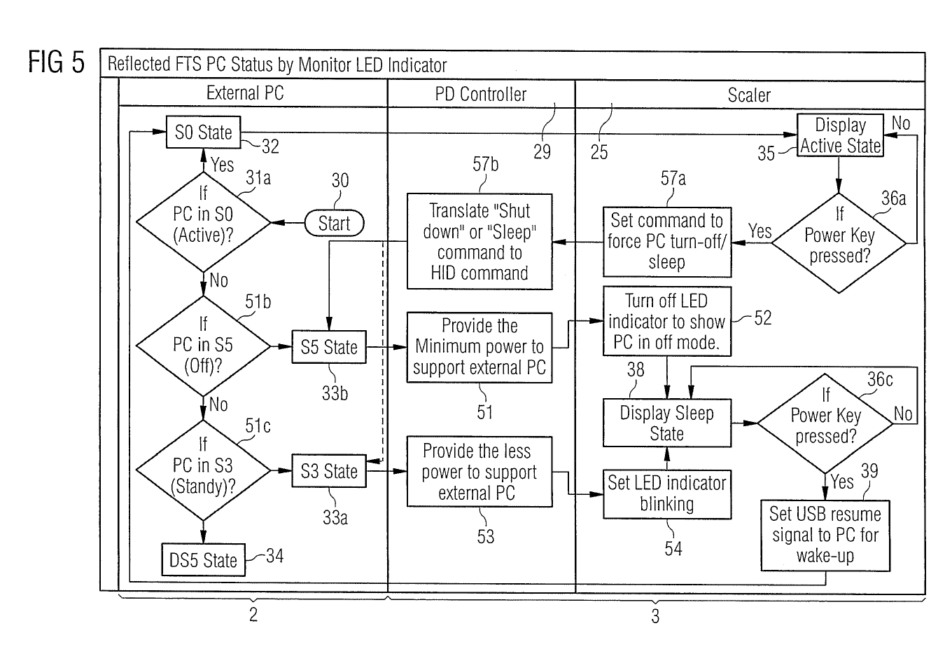

FIG. 5 shows a further flowchart of an operating method for a computer system 1 according to an example. The operating method depicted in FIG. 5 is similar to the operating method explained above with regard to the flowchart of FIG. 3. However, it comprises further implementation details of a communication between the client device 2 and the display device 3 via a display internal power delivery controller 29. FIG. 5 also shows how the status LED 8 of the display device 3 can be controlled by the client device 2. The description of those steps already described above with reference to FIG. 3 is not repeated here.

As before, the client device 2 can be operated in a number of different power states, in particular, in the standard ACPI states S0 (box 32), S3 (box 33a) and S5 (box 33b), as well as in the vendor specific, deep sleep state DS5 (box 34). The sequence of mode checks has been slightly altered to first check whether the client device 2 is in the ACPI S5 state (box 51b), before checking whether it is in the ACPI S3 state (box 51c).

As shown in FIG. 5, the scaler 25 of the display device 3 is responsible for monitoring the power button 7 and controlling the status LED 8. If a pressing of the power button 7 is recognized (box 36a) while the client device 2 is in the ACPI state S0 (box 32) and the display in the “display active” state (box 35), the scaler 25 sets a “shut down” command or flag to force the PC to be turned off (box 57a). This command is communicated via an internal communication path such as an I²C bus to the power delivery controller 29. The power delivery controller 29 receives the command and translates the “shut down” command into a corresponding HID command (box 57b). This command is communicated using the USB control path 22 to a corresponding component of the client device 2. For example, the power management subsystem 13 of the client device 2 may receive a HID command corresponding to a HID command that would be generated by a keyboard with a dedicated power button as defined in the table below, and recognize it as a command to turn the client device 2 off. Accordingly, the client device 2 will enter the ACPI state S5 (box 33b).

As a consequence, the power consumption of the client device 2 will drop significantly, for example, to a power consumption of below 1 W. The power delivery controller 29 will recognize that the power delivered to the client device 2 has dropped below this threshold and signal to the scaler 25 that only a minimum power is provided to the client device 2 (box 51). In response to receiving this information over the I²C bus, the scaler 25 will turn off the LED indicator to show that the client device 2 is in a “switched-off” ACPI state S5 (box 52).

Moreover, the scaler 25 will also enter the display sleep state (box 38) until the power button 7 is pressed again (box 36c). In this case, the scaler 25 will generate the USB resume signal to wake up the client device 2 (box 39). The client device 2 will therefore enter the ACPI state S0 as detailed above with regard to FIG. 3 (box 32).

Alternatively, the scaler 25 may set an internal “sleep” command or flag. In this case, another energy saving mode such as the ACPI S3 mode may be signaled by the power delivery controller 29 and/or selected by the power management subsystem 13 as described, for example, with reference to FIG. 3 above. This is indicated in FIG. 5 using the dashed line between box 57b and box 33a.

When the client device 2 enters the ACPI state S3 (box 33a), this is also recognized by the power delivery controller 29. For example, the power delivery controller 29 may recognize that a power in the range between 1 and 5 W is consumed by the client device 2 (box 53). In response, it signals a corresponding control signal to the scaler 25, which sets the status LED 8 into a blinking mode to indicate the standby state of the client device 2 to the user (box 54) and then enters the display sleep state (box 38).

The following table defines a mapping of display device internal I²C commands to standardized USB HID commands as defined in the Device Class Definition for Human Interface Devices (HID) Firmware specification Version 1.1 and the corresponding HID Usage Table Version 1.11, both dated Jun. 27, 2001, the HID Usage Table Version 1.12, dated Oct. 28, 2004, and other USB control signals as defined, for example, in the USB Specification Revision 1.1, dated Sep. 23, 1998. Those HID commands and USB control signals can be recognized by the power management subsystem 13 or system software of the client device 2 accordingly, without the need for a vendor specific driver software. However, it may be necessary to activate a function for allowing external devices in general and/or the display device 3 in particular to wake the client device 2. Moreover, the client device 2 and/or the display device 3 should power their respective USB interfaces in all modes, from which a re-activation of the normal operating mode is intended, i.e., at least in the ACPI S3 state, preferably also in the ACPI S5 state. The respective USB interface may need to be configured in the client device's firmware such as a BIOS or UEFI program, to keep the USB interface alive in an energy saving state, in particular in the ACPI S5 state. Typical system software will search for application collections tagged with any HID device. When found, the usages generated by these collections will be treated as standard system keyboard input.

| | HID Command or | |
|---|---|---|
| FTS internal | other USB control | |
| command | signal | Description |
| “Lock PC” | “Win” + “L” key | HID command emulating keyboard |
| | command | shortcut for locking the user interface |
| “Sleep” | System Sleep | Standardized or OEM specific System |
| | | Control/Power Control Command |
| | | (e.g., hex code 01 82 00 or 0A 82 00) |
| “Wake up” | USB Resume | USB bus state as defined in section |
| (if PC is in | signal | 7.1.7 of USB Specification Revision |
| S3 state) | | 1.1 |
| “Turn on” | USB Resume | USB bus state as defined above |
| (if PC is in | signal | |
| S4 or S5 | | |
| state) | | |
| “Shut down” | System Power | Standardized or OEM specific System |
| | Down | Control/Power Control Command |
| | | (e.g., hex code 01 81 00 or 0A 81 00) |
| “Hibernate” | System | Standardized or OEM specific System |
| | Hibernate | Control/Power Control Command |
| | | (e.g., hex code 01 A8 00 or 0A A8 00) |

As an alternative to the USB Resume signal, a standardized or OEM specific System Control/Power Control Command for USB System Wake Up (e.g., hex code 01 83 00 or 0A 83 00) may be used to translate the internal “Wake Up” command. However, the USB Resume signal can be detected by the client device 2 without having an active USB data path established, as it is signaled on a lower, physical level of the USB protocol by changing the polarity of the D+ and D− data lines, whereas Power Control Commands can only be interpreted by the client device 2 if a data path is established, which is usually not the case if the client device 2 is in an energy saving state such as the ACPI states S3 or S5.

It may be beneficial for the display device 3 simulating the keyboard or other HID device to make use of several ones of the control pages as defined in the HID Usage Tables. For example, in one state, the control page could be set to the keyboard/keypad page (0x07) to simulate standard keyboard behavior and transmit ordinary keystrokes such as the “Win”+“L” key. In another state, the control page could be set to the generic desktop page (0x01) to issue Power Control commands. However, in other implementations, all HID commands could be chosen from a single control page such as the ordinal page (0x0A) to simplify the implementation of the corresponding controller state machine.

All the above mentioned HID commands and USB control signals, including the USB Resume signal can be signaled over the data lines comprised in a standard USB interface. That is to say, no further control or signaling lines are required in the examples. Moreover, as the detection and/or decoding of the above signals can be performed by USB compliant hard- and software components, no further modifications of such components are required to implement the system.

1. A computer system comprising:
a client computing device; and
a display device operationally connected to the client computing device by a Universal Serial Bus, USB, interface,
wherein
the display device comprises at least one power control device comprising at least one of a power button and a user presence sensor; and
upon activation, the at least one power control device changes an operating state of the client computing device by sending at least one predefined Human Interface Device, HID, command or a resume signal over data lines of the USB interface to the client computing device.

2. The computer system according to claim 1, wherein the client computing device and the display device are coupled by a USB Type-C cable configured for delivery of data, a video signal and power or by a USB Type-A cable configured for delivery of data.

3. The computer system according to claim 1, wherein the display device further comprises at least one power indication device that indicates a current operating state of the client computing device.

4. The computer system according to claim 3, wherein the display device provides an operating energy to the client computing device, and the display device detects the current operating state of the client computing device based on an amount of operating energy provided from the display device to the client computing device.

5. The computer system according to claim 3, wherein the client computing device transmits at least one control signal to the display device, the at least one control signal indicating the current operating state of the client computing device.

6. The computer system according to claim 1, wherein the display device comprises a user presence sensor, and wherein the computer system, upon detection of the absence of a user by the presence sensor, locks the client computing device, and/or, upon detection of the presence of the user by the presence sensor, wakes up the client computing device or displays a log-in screen.

7. A client computing device comprising:
at least one processor that executes program code;
a graphics component that generates graphical output to be displayed based on the program code executed by the at least one processor;
a power management subsystem that switches the client computing device into different operating states, including at least one normal operating state in which the at least one processor is supplied with an operating energy, and at least one energy saving state in which the at least one processor is not supplied with the operating energy or supplied with a reduced amount of operating energy; and
at least one Universal Serial Bus, USB, interface to connect the client computing device to an external display device,
wherein
the power management subsystem controls the operating state of the client computing device based on a first control signal received from the external display device over data lines of the USB interface, the first control signal comprising at least one predefined Human Interface Device, HID, command or a resume signal according to the Universal Serial Bus, USB, protocol and indicating a request for the power management subsystem to change the operating state of the client computing device, and
one of the power management subsystem and the USB interface transmits a second control signal to the external display device indicating a change in a current operating state of the client computing device.

8. The client computing device according to claim 7, wherein the at least one HID command comprises one selected from the group consisting of a HID command emulating a keyboard shortcut and a Power Control Command according to a HID Usage Table.

9. The client computing device according to claim 7, wherein a firmware of the client computing device and/or the USB interface comprise software code that, one execution, detects whether a display capable to transmit the first control signal and to receive the second control signal is connected externally to the client computing device via the at least one USB interface, before receiving the first control signal and/or transmitting the second control signal.

10. A display device comprising:
a display screen that displays graphical output;
at least one power control device comprising at least one of a power button and a user presence sensor;
at least one USB interface that connects the display device to an external client computing device; and
control circuitry operationally connected to the at least one power control device and the at least one USB interface,
wherein
the control circuitry monitors the at least one power control device and, upon activation of the at least one power control device, transmits a first control signal comprising at least one predefined Human Interface Device, HID, command or a resume signal according to the Universal Serial Bus, USB, protocol over data lines of the USB interface to the client computing device indicating a request to change the operating state of the client computing device.

11. The display device according to claim 10, wherein the control circuitry determines how long the power control device was actuated, sends a first HID command for activation of a first energy saving state of the external client computing device, if the power control device was actuated for less than a first period, and sends a second HID command for activation of a second energy saving state of the external client computing device, if the power control device was actuated for more than the first period.

12. The display device according to claim 10, further comprising at least one power indication device connected to the control circuitry, wherein the control circuitry detects the current operating state of the client computing device and indicates the detected operating state of the client computing device by using the at least one power indication device of the display device.

13. The display device according to claim 12, wherein the control circuitry detects the current operating state of the client computing device by detecting a power consumption of the client computing device.

14. The display device according to claim 13, further comprising a power delivery controller that provides an operating energy for the client computing device to the at least one USB interface, wherein the power delivery controller detects the current operating state of the client computing device by comparing the operating energy provided to the at least one USB interface with at least one threshold value.

15. The display device according to claim 14, wherein a switched-off state of the client computing device is detected when the operating energy provided to the at least one USB interface is below a first threshold, an energy saving state of the client computing device is detected when the operating energy is equal to or above the first threshold and is equal to or below a second threshold, and a normal operating state of the client computing device is detected when the operating energy is above the second threshold.

16. The display device according to claim 12, wherein the control circuitry detects the current operating state of the client computing device by receiving a second control signal, wherein the second control signal is received via the data lines of the at least one USB interface from the client computing device and indicates the current operating state of the client computing device.

17. The display device according to claim 16, wherein the control circuitry switches the at least one display screen into at least one display sleep state when second control signal indicates that the client computing device has entered an energy saving state.

18. The display device according to claim 16, wherein the second control signal comprises one of a further HID command or a vendor defined message, VDM.

19. The display device according claim 10, wherein the control circuitry comprises a scaler and one of a USB hub or a power delivery controller connected to the scalar by an internal control interface, and wherein the scaler provides an internal command to the USB hub or the power delivery controller, respectively, and the USB hub or the power delivery controller, respectively, translates the internal command into the first control signal transmitted to the external client computing device.

20. The display device according to claim 10, wherein the display device is a flat screen display device.
